(19) United States
(12) Patent Application Publication
(10) Pub. No.: US 2024/0061130 A1
(43) Pub. Date: Feb. 22, 2024

(54) HIGH-PRECISION POSITIONING METHOD AND SYSTEM FOR HIGH-SPEED TRAIN

(71) Applicant: East China Jiaotong University, Nanchang (CN)

(72) Inventors: Hui YANG, Nanchang (CN); Shuaiqiang DONG, Nanchang (CN); Chunhua XIE, Nanchang (CN); Zhiyu LI, Nanchang (CN); Ming JIANG, Nanchang (CN)

(21) Appl. No.: 18/053,121

(22) Filed: Nov. 7, 2022

(30) Foreign Application Priority Data
Aug. 16, 2022 (CN) 202210978775.0

(51) Int. Cl. G01S 19/47; G01S 19/40

(52) U.S. Cl. CPC G01S 19/47; G01S 19/40

(57) ABSTRACT

A high-precision positioning method and system for a high-speed train is provided, which belongs to the technical field of high-speed train positioning. A multi-objective optimization model is first established. An objective function is a function obtained by weighing a positioning error function of the BeiDou satellite navigation system, a distance error function and a direction error function of the inertial navigation system. Constraint conditions include a positioning error constraint of the BeiDou satellite navigation system, a distance error constraint and a direction error constraint of the inertial navigation system, and a positioning error constraint of an electronic map. The multi-objective optimization model is solved with first positioning data of the BeiDou satellite navigation system and second positioning data of the inertial navigation system as inputs thereof by using an improved differential evolution algorithm, to obtain optimal positioning data of the high-speed train.

### CROSS REFERENCE TO RELATED APPLICATION

This patent application claims the benefit and priority of Chinese Patent Application No. 202210978775.0 filed with the China National Intellectual Property Administration on Aug. 16, 2022, the disclosure of which is incorporated by reference herein in its entirety as part of the present application.

### TECHNICAL FIELD

The present disclosure relates to the technical field of high-speed train positioning, and in particular, to a high-precision positioning method and system for a high-speed train based on integration of a BeiDou satellite navigation system, an inertial navigation system, and an electronic map.

### BACKGROUND

The railway transportation industry is one of the pillar industries of China's national economy. With the rapid development of railway transportation, how to improve transportation efficiency, reduce operation and maintenance costs, and ensure the safety of transportation process has become a new concern for railway transportation. For this problem, the realization of continuous autonomous positioning of trains and the establishment of a more advanced and complete intelligent control system for train operation are effective solutions. In addition, the continuous and autonomous positioning of trains is also a prerequisite for building a safe, convenient, efficient, economical and environment-friendly railway transportation network.

In recent years, the main researches on train positioning can be divided into four aspects: multi-sensor information fusion, wireless sensor network, heuristic algorithm and electronic map matching. The multi-sensor information fusion is a positioning method for high-speed trains by reasonably combining information measured by each sensor according to a certain criterion. The wireless sensor network is a distributed sensor network, which consists of sensors or mobile base stations distributed along the railway and receiving equipment on the train. The positioning methods of the network are mainly divided into four types: a signal strength positioning method, a direction measurement positioning method, a time-of-arrival positioning method and a time-difference-of-arrival positioning method. The heuristic algorithm is mainly used to solve multi-sensor information fusion and wireless sensor network problems, among which the most representative ones are fuzzy control theory, genetic algorithm and artificial neural network. The electronic map matching is an auxiliary positioning method that eliminates the longitudinal error of the railway track by matching positioning results of other positioning systems with the electronic track map to realize more precise positioning.

At present, the research on fusion positioning methods for high-speed trains is mainly aimed at the fusion positioning between various navigation systems and sensor networks, but the positioning precision of the existing methods is limited and cannot achieve the high-precision positioning of trains. Electronic map matching can improve the positioning precision, but information transmission takes a lot of time, so few studies use electronic map matching in the fusion positioning process, and high-precision positioning combined with map information has not been realized.

Based on this, there is an urgent need for a high-precision positioning technology for a high-speed train based on electronic maps.

### SUMMARY

An objective of the present disclosure is to provide a high-precision positioning method and system for a high-speed train, which integrates the BeiDou satellite navigation system, the inertial navigation system and the electronic map, and uses an improved differential evolution algorithm for solution, thereby improving the reliability of high-speed train positioning and realizing high-precision positioning of the high-speed train.

In order to achieve the above objective, the present disclosure provides the following technical solutions:

A high-precision positioning method for a high-speed train, comprising:
acquiring first positioning data obtained by positioning the high-speed train through a BeiDou satellite navigation system and second positioning data obtained by positioning the high-speed train through an inertial navigation system;
solving a multi-objective optimization model with the first positioning data and the second positioning data as inputs thereof, by using an improved differential evolution algorithm, to obtain optimal positioning data of the high-speed train, where the multi-objective optimization model includes an objective function and constraint conditions; the objective function is a function obtained by weighing a positioning error function of the BeiDou satellite navigation system, a distance error function of the inertial navigation system and a direction error function of the inertial navigation system; and the constraint conditions include a positioning error constraint of the BeiDou satellite navigation system, a distance error constraint and a direction error constraint of the inertial navigation system, and a positioning error constraint of an electronic map.

A high-precision positioning system for a high-speed train, comprising:
a positioning data acquiring module configured to acquire first positioning data obtained by positioning the high-speed train through a BeiDou satellite navigation system and second positioning data obtained by positioning the high-speed train through an inertial navigation system;
an optimization module configured to solve a multi-objective optimization model with the first positioning data and the second positioning data as inputs thereof, by using an improved differential evolution algorithm, to obtain optimal positioning data of the high-speed train, wherein the multi-objective optimization model comprises an objective function and constraint conditions; the objective function is a function obtained by weighing a positioning error function of the BeiDou satellite navigation system, a distance error function of the inertial navigation system and a direction error function of the inertial navigation system; and the constraint conditions comprise a positioning error constraint of the BeiDou satellite navigation system, a distance error constraint and a direction error constraint of the inertial navigation system and a positioning error constraint of the electronic map.

According to specific embodiments of the present disclosure, the present disclosure discloses the following technical effects:

The present disclosure aims to provide a high-precision positioning method and system for a high-speed train. A multi-objective optimization model is first established. The multi-objective optimization model includes an objective function and constraint conditions. The objective function is a function obtained by weighing a positioning error function of the BeiDou satellite navigation system, a distance error function of the inertial navigation system and a direction error function of the inertial navigation system. The constraint conditions include a positioning error constraint of the BeiDou satellite navigation system, a distance error constraint and a direction error constraint of the inertial navigation system and a positioning error constraint of an electronic map. Electronic map information is added to a high-speed train positioning process in the form of track constraints. First positioning data obtained by positioning the high-speed train through the BeiDou satellite navigation system and second positioning data obtained by positioning the high-speed train through the inertial navigation system are acquired. Then the multi-objective optimization model is solved with the first positioning data and the second positioning data as inputs thereof by using an improved differential evolution algorithm, to obtain optimal positioning data of the high-speed train. The BeiDou satellite navigation system, the inertial navigation system and the electronic map are integrated, and the improved differential evolution algorithm is used for solution, thereby improving the reliability of high-speed train positioning and realizing high-precision positioning of the high-speed train.

### BRIEF DESCRIPTION OF THE DRAWINGS

To describe the technical solutions in the embodiments of the present disclosure or in the prior art more clearly, the accompanying drawings required for the embodiments are briefly described below. Apparently, the accompanying drawings in the following description are merely some embodiments of the present disclosure, and those of ordinary skill in the art may still derive other accompanying drawings from these accompanying drawings without creative efforts.

FIG. 1 is a flow chart of a positioning method according to Embodiment 1 of the present disclosure;

FIG. 2 is a schematic block diagram of the positioning method according to Embodiment 1 of the present disclosure;

FIG. 3 is a schematic diagram of a mutation operation of an improved differential evolution algorithm according to Embodiment 1 of the present disclosure;

FIG. 4 is a solution flow chart of the improved differential evolution algorithm according to Embodiment 1 of the present disclosure;

FIG. 5A-D are comparison diagrams of positions before and after positioning in a simulation experiment according to Embodiment 1 of the present disclosure;

FIG. 6 is a comparison diagram of errors before and after positioning in the simulation experiment according to Embodiment 1 of the present disclosure;

FIG. 7 is a block diagram of a positioning system according to Embodiment 2 of the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

An objective of the present disclosure is to provide a high-precision positioning method and system for a high-speed train, which integrates the BeiDou satellite navigation system, the inertial navigation system and the electronic map, and uses an improved differential evolution algorithm for solution, thereby improving the reliability of high-speed train positioning and realizing high-precision positioning of the high-speed train.

To make the above-mentioned objective, features and advantages of the present disclosure clearer and more comprehensible, the present disclosure will be further described in detail below in conjunction with the accompanying drawings and specific embodiments.

### Embodiment 1

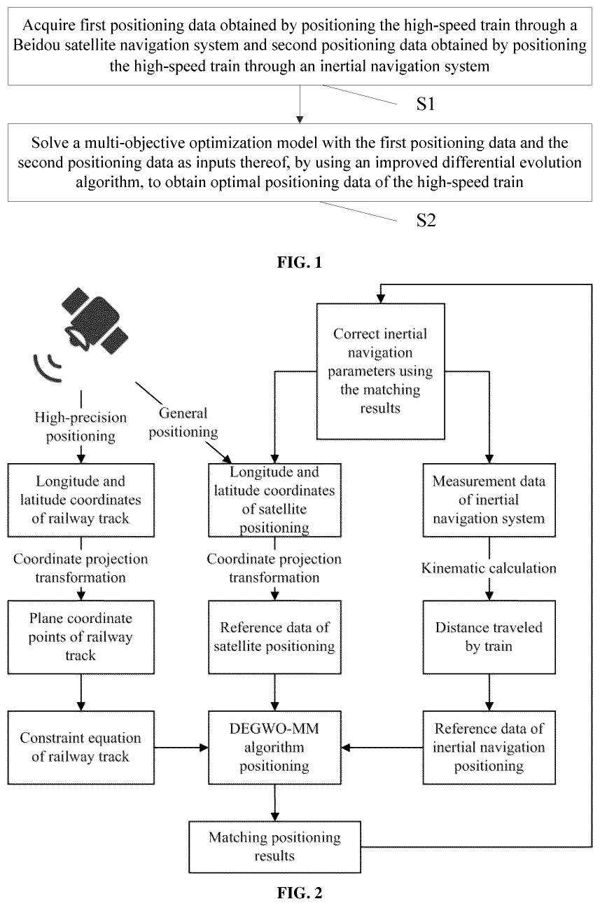

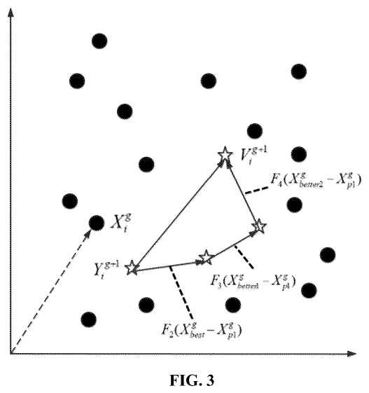

The present embodiment provides a high-precision positioning method for a high-speed train, as shown in FIG. 1 and FIG. 2, including the following steps S1 to S2.

In step S1, first positioning data obtained by positioning the high-speed train through a BeiDou satellite navigation system and second positioning data obtained by positioning the high-speed train through an inertial navigation system are acquired.

In step S2, with the first positioning data and the second positioning data as inputs of a multi-objective optimization model, the multi-objective optimization model is solved by using an improved differential evolution algorithm, to obtain optimal positioning data of the high-speed train. The multi-objective optimization model includes an objective function and constraint conditions. The objective function is a function obtained by weighing a positioning error function of the BeiDou satellite navigation system, a distance error function of the inertial navigation system and a direction error function of the inertial navigation system. The constraint conditions include a positioning error constraint of the BeiDou satellite navigation system, a distance error constraint and a direction error constraint of the inertial navigation system and a positioning error constraint of an electronic map.

In the present embodiment, the positioning error, the direction error, and the distance error are weighted to form the objective function, and the positioning error range and the track equation of the electronic map are transformed into constraint conditions. Thus, the high-speed train positioning problem that integrates the BeiDou satellite navigation system, the inertial navigation system and the electronic map is transformed into a multi-objective optimization problem. The multi-objective optimization model is established and solved by using the improved differential evolution algorithm, to obtain the optimal positioning data of the high-speed train.

Specifically, the multi-objective optimization model in the present embodiment includes an objective function and constraint conditions.

According to an analysis on a train positioning system, the objective function required for train positioning is designed. The establishment process of the objective function is as follows.
(1) A fitness function ƒ₁ is obtained from the positioning error of the BeiDou satellite navigation system, and ƒ₁ is used as the positioning error function of the BeiDou satellite navigation system, which is the distance from the coordinates of an individual to the reference coordinates of the BeiDou satellite navigation system, as follows:

ƒ₁=∥pp(i,t)−sp(t)∥,

where pp(i,t) is an i-th individual for the current positioning t (indicating that the current positioning is the t-th positioning); sp(t) is first positioning data for the current positioning t, obtained from positioning by the BeiDou satellite navigation system; ∥pp(i,t)−sp(t)∥ represents a modulo length from the i-th individual generated by the current positioning t to the first positioning data obtained by the BeiDou satellite navigation system. It should be noted that the positioning data in the present embodiment refers to the position coordinates of the high-speed train.
(2) A fitness function ƒ₂ is obtained from the distance error of the inertial navigation system, and ƒ₂ is used as the distance error function of the inertial navigation system, which is the distance from the coordinates of the individual to the reference coordinates of the inertial navigation system, as follows:

ƒ₂=∥pp(i,t)−s(t)∥,

where s(t) is second positioning data of the current positioning t, which is obtained from positioning by the inertial navigation system; ∥pp(i,t)−s(t)∥ represents the modulo length from the i-th individual generated by the current positioning t to the second positioning data obtained by the inertial navigation system.
(3) A fitness function ƒ₃ is obtained from the direction error of the inertial navigation system, and ƒ₃ is used as the direction error function of the inertial navigation system, which is the direction error corresponding to the coordinates of the individual, as follows:

$$\begin{matrix}{f}_{3} = \vert {ϕ}_{p p ( i , t ) s ( t - 1 )} - {ϕ}_{t} \vert \\ = \vert arc tan ( \frac{{X}_{p p ( i , t )} - {X}_{s ( t - 1 )}}{{Y}_{p p ( i , t )} - {Y}_{s ( t - 1 )}} , \frac{{Y}_{p p ( i , t )} - {Y}_{s ( t - 1 )}}{{Z}_{p p ( i , t )} - {Z}_{s ( t - 1 )}} , \frac{{Z}_{p p ( i , t )} - {Z}_{s ( t - 1 )}}{{X}_{p p ( i , t )} - {X}_{s ( t - 1 )}} ) - {ϕ}_{t} \vert\end{matrix} ,$$

where ϕ_{pp(i,t)s(t-1)} is an azimuth variation between the i-th individual for the current positioning t and optimal positioning data obtained from previous positioning t−1; ϕₜ is an azimuth variation measured by the inertial navigation system at the current positioning t.

It should be noted that X _{pp(i,t)}, Y_{pp(i,t)} and Z_{pp(i,t)} are three-dimensional position coordinates of the i-th individual of the current positioning t; Xₛ₍ₜ₋₁₎, Yₛ₍ₜ₋₁₎ and Zₛ₍ₜ₋₁₎ are three-dimensional position coordinates of the optimal positioning data obtained from the previous positioning t−1.
(4) The corresponding fitness functions are weighted by using the reciprocal of the maximum error, so as to transform the multi-objective optimization problem into a single-objective optimization problem. Since the BeiDou satellite navigation system is an absolute positioning system, the error thereof is not related to time, while the error of the inertial navigation system is related to time, so the weighting coefficient of the BeiDou satellite navigation system adopts the reciprocal of the maximum error, the weighting coefficient of the inertial navigation system adopts the reciprocal of the maximum error before the current positioning, and the weighted objective function is:

$$F ( t ) = \frac{1}{{( {e}_{s}^{max} )}^{2}} {f}_{1} + \frac{1}{{( max ( {e}_{1} ) )}^{2}} {f}_{2} + \frac{1}{{( max ( {e}_{2} ) )}^{2}} {f}_{3} ,$$

where F(t) is the objective function of current positioning t; eₛ^{max} is the maximum error range of the BeiDou satellite navigation system (which can be set to 15 m in the present embodiment); ƒ₁ is the positioning error function of the BeiDou satellite navigation system; max(e₁) is the maximum distance error of the inertial navigation system before the current positioning t; ƒ₂ is the distance error function of the inertial navigation system; max(e₂) is the maximum direction error of the inertial navigation system before the current positioning t; ƒ₃ is the direction error function of the inertial navigation system.

The present embodiment establishes a constraint equation according to the electronic map and high-speed train positioning requirements, and obtains the constraint conditions of the multi-objective optimization problem of high-speed train positioning, that is, the constraint conditions of the multi-objective optimization model are as follows.
(1) The constraint inequality obtained from the positioning error of the BeiDou satellite navigation system, that is, the positioning error constraint of the BeiDou satellite navigation system is:

0≤∥pp(i,t)−sp(t)∥≤eₛ^{max},
(2) The constraint inequality obtained from the distance error of the inertial navigation system, that is, the distance error constraint of the inertial navigation system is:

0≤∥pp(i,t)−s(t)∥e₂^{max},

where e₂^{max} is a maximum distance error allowed by the inertial navigation system.
(3) The constraint inequality obtained from the direction error of the inertial navigation system, that is, the direction error constraint of the inertial navigation system is:

0≤|ϕ_{pp(i,t)s(t-1)}−ϕₜ|≤e₃^{max},

where |ϕ_{pp(i,t)s(t-1)}−ϕₜ| represents an absolute value of the direction error; e₃^{max} is a maximum direction error allowed by the inertial navigation system.
(4) The constraint inequality obtained from the high-speed railway track equation (obtained based on the electronic map), that is, the positioning error constraint of the electronic map is:

$$\{ \begin{matrix}- 0.7 \leq y - {f}_{1} ( x ) \leq 0.7 \\ - 0 \text{.2} \leq 𝓏 - {f}_{2} ( x ) \leq 0.2\end{matrix} ,$$

where y and [symbol] are actual coordinates in third positioning data obtained by positioning the high-speed train through the electronic map, and the third positioning data is the position of the high-speed train displayed on the electronic map; ƒ₁(x) and ƒ₂(x) are fitted coordinates obtained by positioning the high-speed train according to a curve function of y and [symbol] with respect to x in the WGS84 coordinate system obtained by fitting point data of the electronic map. Therefore, the electronic map information is added to the high-speed train positioning process in the form of track constraints, so as to save the time for data transmission required for map matching and positioning, which not only makes the positioning result accurate by using the electronic map information, but also saves the time for data transmission. y, [symbol] , ƒ₁(x) and ƒ₂(x) refer to the coordinates in the WGS84 coordinate system, where x is the longitude, y is the latitude, and [symbol] is the elevation. The rail gauge of the current high-speed railway line is 1.435 m, so the plane error is set to ±0.7 m, and the elevation error is set to ±0.2 m.

It should be noted that before starting positioning, the present embodiment will fit the point data of the electronic map of the high-speed train track between two stations into a straight line, a circular curve, and a transition curve to obtain the track equation that can reasonably describe the characteristics of the high-speed train track between the two stations. During the current positioning, the corresponding track equation will be selected according to the first positioning data and the second positioning data, that is, ƒ₁(x) and ƒ₂(x) are obtained.

Preferably, after the first positioning data of the BeiDou satellite navigation system, the second positioning data of the inertial navigation system, and the third positioning data of the electronic map of the high-speed train operation track are obtained, the present embodiment will perform data preprocessing, as follows: performing projection transformation on the coordinates, to unify the first positioning data, the second positioning data and the third positioning data into the same map coordinate system, which may be the WGS84 coordinate system in the present embodiment; performing data filtering using the density-based spatial clustering of applications with noise (DBSCAN) method to eliminate invalid data, which includes the following specific operations: for the first positioning data, if it is abnormal, deleting the data; for the second positioning data and the third positioning data, if it is abnormal, deleting the data and performing fitting and interpolation processing.

In the present embodiment, a solution algorithm for the high-speed train positioning problem based on the integration of the BeiDou satellite navigation system, the inertial navigation system and the electronic map is designed, and the algorithm is improved according to the high-speed train positioning requirements. Specifically, the mutation operation of the differential evolution algorithm is improved by referring to the idea of the gray wolf algorithm, that is, the improved differential evolution algorithm in the present embodiment is obtained by improving the mutation operation of the differential evolution algorithm. The mutation operation of the improved differential evolution algorithm is as follows.
(1) Individuals in a current generation population are arranged in a descending order according to objective function values, and first three individuals are selected as optimal individuals.
(2) Three individuals are randomly selected from other individuals in the current generation population except the optimal individuals, and a new individual is reconstructed according to the three individuals.

Reconstructing a new individual according to the three individuals means that a new individual is formed by a difference vector between one of the individuals and the other two individuals. Specifically, reconstructing a new individual according to the three individuals may include: randomly selecting one of the three individuals as an original individual; calculating a first difference between the other two individuals in the three individuals except the original individual, and calculating a product of the first difference and a first variation factor to obtain a first variation; and calculating a sum of the original individual and the first variation, and reconstructing a new individual.
(3) An individual in a next generation population is generated according to the new individual and the optimal individuals.

Generating an individual in a next generation population according to the new individual and the optimal individuals means that an individual in a next generation population is generated by adding the new individual with respective difference vectors between the original individual and respective optimal individuals. Specifically, generating an individual in a next generation population according to the new individual and the optimal individuals may include: recording the optimal individuals as a first individual, a second individual and a third individual; calculating a second difference between the first individual and the original individual, and calculating a product of the second difference and a second variation factor to obtain a second variation; calculating a third difference between the second individual and the original individual, and calculating a product of the third difference and a third variation factor to obtain a third variation; calculating a fourth difference between the third individual and the original individual, and calculating a product of the fourth difference and a fourth variation factor to obtain a fourth variation; and calculating a sum of the new individual, the second variation, the third variation and the fourth variation to obtain an individual in the next generation population.
(4) Whether a number of individuals in the next generation population is equal to a number of individuals in the current generation population is determined, if yes, the mutation operation is completed, and if not, the method returns to the randomly selecting three individuals from other individuals in the current generation population except the optimal individuals.

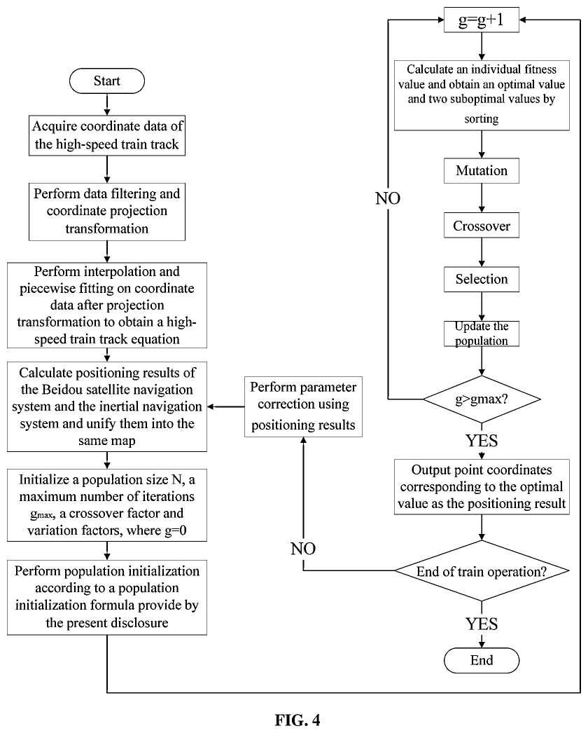

As shown in FIG. 3, the above mutation operation includes the following formula:

$$\{ \begin{matrix}{X}_{i}^{g} = ( {x}_{i , 1}^{g} , {x}_{i , 2}^{g} , … , {x}_{i , d}^{g} ) \\ {Y}_{i}^{g + 1} = {X}_{p 1}^{g} + {F}_{1} ( {X}_{p 2}^{g} - {X}_{p 3}^{g} ) \\ {V}_{i}^{g + 1} = {Y}_{i}^{g + 1} + {F}_{2} ( {X}_{best}^{g} - {X}_{p 1}^{g} ) + {F}_{3} ( {X}_{better 1}^{g} - {X}_{p 1}^{g} ) + {F}_{4} ( {X}_{better 2}^{g} - {X}_{p 1}^{g} )\end{matrix} ,$$

where Xᵢ^{g} is the i-th individual in the g-th generation population, which is a d-dimensional vector, and in the present embodiment, since the positioning data is a 3-dimensional coordinate, d is 3; Yᵢ^{g+1} is a new individual generated during the mutation operation; Xₚ₁^{g}, Xₚ₂^{g} and Xₚ₃^{g} are three individuals randomly selected from the g-th generation population, p1≠p2≠p3 and the three individuals are not optimal individuals, and Xₚ₁^{g} is the original individual; Vᵢ^{g+1} is the i-th individual in the g+1-th generation population; X_{best}^{g}, X_{better1}^{g} and X_{better2}^{g} are the optimal individuals in the g-th generation population; F₁, F₂, F₃ and F₄ are the first variation factor, the second variation factor, the third variation factor and the fourth variation factor respectively, F₁ can be obtained by rand(0, 0.5), and F₂, F₃ and F₄ can be obtained by rand(0, 0.25).

The present embodiment improves the mutation operation of the differential evolution algorithm, which not only improves the solution speed of the algorithm, but also prevents the algorithm from falling into local optimum, and improves the performance of the algorithm and the real-time performance of high-speed train positioning.

Combined with the above mutation operations, as shown in FIG. 4, the improved differential evolution algorithm is used to solve the multi-objective optimization model transformed from the high-speed train positioning problem based on the integration of the BeiDou satellite navigation system, the inertial navigation system and the electronic map, so as to obtain positioning results of the high-speed train, that is, the solution using the improved differential evolution algorithm can include the following steps.
(1) The point data of the electronic map is filtered to eliminate invalid map data, and after interpolation, piecewise fitting is performed according to the stations to establish track equations. The first positioning data of the BeiDou satellite navigation system and the second positioning data of the inertial navigation system are obtained, and filtered to eliminate invalid data, and an appropriate track equation is selected from the track equations obtained through piecewise fitting according to the first positioning data and the second positioning data. The first positioning data is subjected to coordinate projection transformation so as to be unified into the same coordinate system with the second positioning data and the third positioning data. Then, the first positioning data, the second positioning data, the third positioning data and the appropriate track equation are all substituted into the multi-objective optimization model. At this time, only the individual is unknown in the multi-objective optimization model.

The population size N, the maximum iteration number gₘₐₓ, the crossover factor and the variation factors F₁, F₂, F₃ and F₄ are set.
(2) An initial population is randomly generated according to the second positioning data.

Specifically, an initial population is generated by way of adding the second positioning data with random values within an error range to complete the initialization of the population.

A formula used for population initialization is:

pp(i,t)=s(t)+(r−0.5)*max(e₁),

where pp(i,t) is a three-dimensional coordinate vector, representing a randomly generated i-th initial individual; s(t) is a three-dimensional coordinate vector, representing the second positioning data of the inertial navigation system; and r represents a 1*3 vector randomly generated between (0, 1).

After N individuals are randomly generated using the above formula, the initial population is obtained. In the process of generating individuals, it should be noted that the generated individuals shall satisfy the constraint conditions.
(3) The objective function values of respective individuals in an initial population are calculated respectively, then the mutation operation, the crossover operation and the selection operation are performed on the initial population in sequence according to the objective function values, to obtain a new population.

In the process of generating a new population, it should be noted that the generated individuals shall satisfy the constraint conditions.
(4) Whether a maximum iterations number is reached is determined, if yes, that is, when the current iteration number g>gₘₐₓ, the iteration is ended, and an individual with a maximum objective function value in the new population is selected as an optimal individual, which is the optimal positioning data and is also the output of the final matching positioning result; if not, the iteration is continued, the new population is deemed as an initial population in a next iteration, and the method returns to the calculating respective objective function values of respective individuals in an initial population.

Preferably, the positioning method in the present embodiment further includes: after the optimal positioning data of the high-speed train is obtained, performing parameter correction on the BeiDou satellite navigation system and the inertial navigation system according to the optimal positioning data, and performing next positioning using the corrected BeiDou satellite navigation system and the corrected inertial navigation system. Specifically, the optimal positioning data obtained by the improved differential evolution algorithm is fed back to the inertial navigation system and the BeiDou satellite navigation system. For the inertial navigation system, the position, speed and acceleration measured by the inertial navigation system are updated and corrected, and positioning is performed on the basis of the optimal positioning data in the next positioning. For the satellite positioning system, the longitude and latitude of the optimal positioning data are compared with the longitude and latitude of the first positioning data to obtain an offset. In the next positioning, the offset is used to perform a certain offset processing on the positioning result of the BeiDou satellite navigation system, so as to reduce the error between two positioning results provided by the two navigation systems in the next positioning.

In the present embodiment, the time interval between two adjacent positioning can be preset to determine the time point of the next positioning, or the time point of the next positioning can be customized according to requirements. No matter which method is used to determine the time point of the next positioning, the present embodiment will continue to perform positioning during operation of the high-speed train until the high-speed train stops running Here, the present embodiment provides a simulation experiment example to further introduce the effect of the positioning method of the present embodiment.

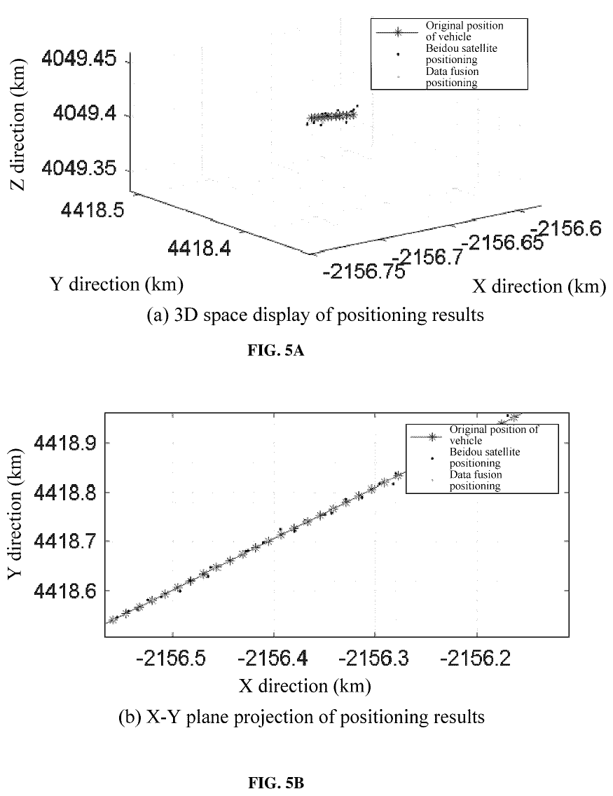

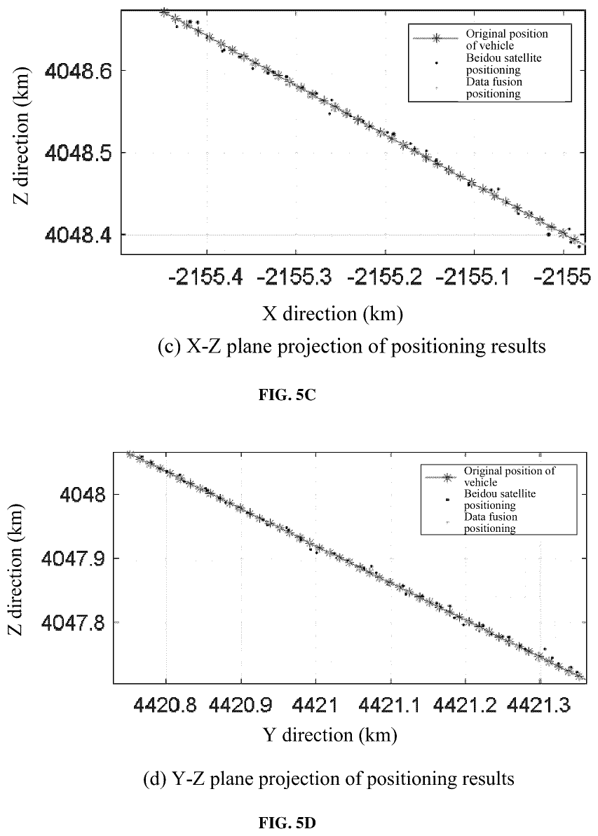

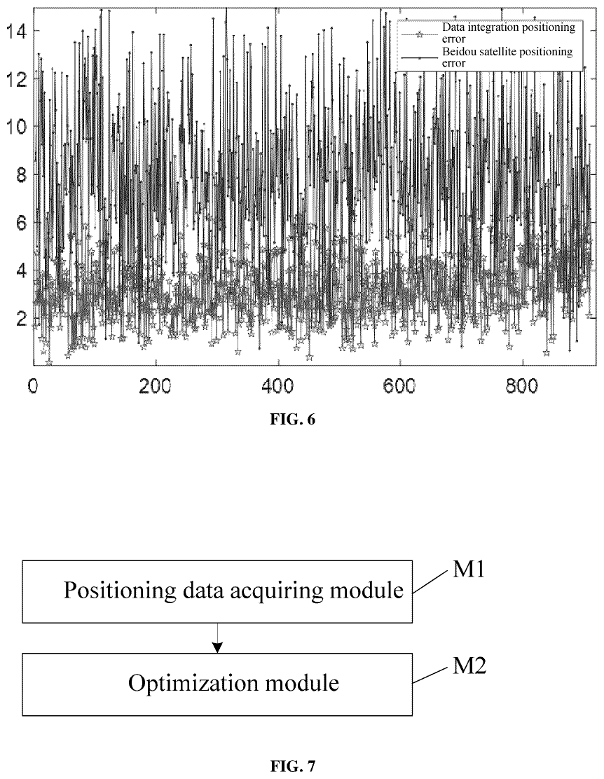

The present embodiment adopts the motion data measured by a car equipped with a BeiDou satellite navigation system provided by the BDS/GNSS Open Laboratory website, and designs a high-speed train positioning simulation experiment based on the integration of the BeiDou satellite navigation system, the inertial navigation system and the electronic map, which is based on MATLAB software. In combination with the comparison diagram of positions before and after positioning in FIG. 5A-D and the comparison diagram of errors before and after positioning in FIG. 6, it can be seen that the positioning method of the present embodiment can improve the positioning precision and reliability of the high-speed train. The simulation data shows that the average time for a single positioning solution is 0.11 s, and the average positioning error is 3.649 m. The results prove that the positioning method for a high-speed train based on integration of the BeiDou satellite navigation system, the inertial navigation system, and the electronic map provided by the embodiment meets the requirements of high-speed train positioning, which can effectively improve the train positioning precision, and is conducive to ensuring the safety of the high-speed train and the establishment of an intelligent train control system.

The present embodiment aims to provide a high-precision positioning method for a high-speed train based on integration of a BeiDou satellite navigation system, an inertial navigation system and an electronic map, which adopts a positioning strategy based on integration of the BeiDou satellite navigation system, the inertial navigation system and the electronic map, it improves the reliability of high-speed train positioning and realizes high-precision positioning of the high-speed train.

### Embodiment 2

The present embodiment aims to provide a high-precision positioning system for a high-speed train, as shown in FIG. 7, including: a positioning data acquiring module M1 and an optimization module M2.

The positioning data acquiring module M1 is configured to obtain first positioning data obtained by positioning the high-speed train through a BeiDou satellite navigation system and second positioning data obtained by positioning the high-speed train through an inertial navigation system.

The optimization module M2 is configured to solving a multi-objective optimization model with the first positioning data and the second positioning data as inputs thereof by using an improved differential evolution algorithm, to obtain optimal positioning data of the high-speed train. The multi-objective optimization model includes an objective function and constraint conditions. The objective function is a function obtained by weighing a positioning error function of the BeiDou satellite navigation system, a distance error function of the inertial navigation system and a direction error function of the inertial navigation system. The constraint conditions include a positioning error constraint of the BeiDou satellite navigation system, a distance error constraint and a direction error constraint of the inertial navigation system and a positioning error constraint of an electronic map.

Compared with the prior art, the significant advantages of the present embodiment are as follows: (1) the high-speed train positioning strategy based on integration of the BeiDou satellite navigation system, the inertial navigation system and the electronic map is proposed, which improves the reliability of high-speed train positioning and realizes high-precision positioning of the high-speed train; (2) the mutation operation of the differential evolution algorithm is improved, which not only improves the solution speed of the algorithm, but also prevents the algorithm from falling into local optimum, and improves the performance of the algorithm and the real-time performance of high-speed train positioning.

All embodiments in this specification focus on the differences from other embodiments. The same or similar portions of these embodiments may refer to one another. Since the system disclosed in an embodiment corresponds to the method disclosed in another embodiment, the description is relatively simple, and reference can be made to the method description.

Specific examples are used herein to explain the principles and embodiments of the present disclosure. The foregoing description of the embodiments is merely intended to help understand the method of the present disclosure and its core ideas; besides, various modifications may be made by those of ordinary skill in the art to specific embodiments and the scope of application in accordance with the ideas of the present disclosure. In conclusion, the content of the present description shall not be construed as limitations to the present disclosure.

What is claimed is:

1. A high-precision positioning method for a high-speed train, comprising:
acquiring first positioning data obtained by positioning the high-speed train through a BeiDou satellite navigation system and second positioning data obtained by positioning the high-speed train through an inertial navigation system;
solving a multi-objective optimization model with the first positioning data and the second positioning data as inputs thereof, by using an improved differential evolution algorithm, to obtain optimal positioning data of the high-speed train, wherein the multi-objective optimization model comprises an objective function and constraint conditions; the objective function is a function obtained by weighing a positioning error function of the BeiDou satellite navigation system, a distance error function of the inertial navigation system and a direction error function of the inertial navigation system; the constraint conditions comprise a positioning error constraint of the BeiDou satellite navigation system, a distance error constraint and a direction error constraint of the inertial navigation system and a positioning error constraint of an electronic map.

2. The positioning method according to claim 1, wherein the objective function is:
$$F ( t ) = \frac{1}{{( {e}_{s}^{max} )}^{2}} {f}_{1} + \frac{1}{{( max ( {e}_{1} ) )}^{2}} {f}_{2} + \frac{1}{{( max ( {e}_{2} ) )}^{2}} {f}_{3} ,$$
where F(t) is an objective function of current positioning t; eₛ^{max} is a maximum error range of the BeiDou satellite navigation system; ƒ₁ is the positioning error function of the BeiDou satellite navigation system; max(e₁) is a maximum distance error of the inertial navigation system before the current positioning t; ƒ₂ is the distance error function of the inertial navigation system; max(e₂) is a maximum direction error of the inertial navigation system before the current positioning t; and ƒ₃ is the direction error function of the inertial navigation system;
ƒ₁=∥pp(i,t)−sp(t)∥,
where pp(i,t) is an i-th individual of the current positioning t; and sp(t) is first positioning data of the current positioning t;
ƒ₂=∥pp(i,t)−sp(t)∥,
where s(t) is second positioning data of the current positioning t;
ƒ₃=|ϕ_{pp(i,t)s(t-1)}−ϕₜ|,
where ϕ_{pp(i,t)s(t-1)} is an azimuth variation between the i-th individual of the current positioning t and optimal positioning data obtained from previous positioning t−1; ϕₜ is an azimuth variation measured by the inertial navigation system at the current positioning t.

3. The positioning method according to claim 2, wherein
the positioning error constraint of the BeiDou satellite navigation system is:
0≤∥pp(i,t)−sp(t)∥≤eₛ^{max},
the distance error constraint of the inertial navigation system is:
0≤∥pp(i,t)−s(t)∥e₂^{max},
where e₂^{max} is a maximum distance error allowed by the inertial navigation system;
the direction error constraint of the inertial navigation system is:
0≤|ϕ_{pp(i,t)s(t-1)}−ϕₜ|≤e₃^{max},
where e₃^{max} is a maximum direction error allowed by the inertial navigation system;
the positioning error constraint of the electronic map is:
$$\{ \begin{matrix}- 0.7 \leq y - {f}_{1} ( x ) \leq 0.7 \\ - 0 \text{.2} \leq 𝓏 - {f}_{2} ( x ) \leq 0.2\end{matrix} ,$$
where y and [symbol] are actual coordinates in third positioning data obtained by positioning the high-speed train through the electronic map; ƒ₁(x) and ƒ₂(x) are fitted coordinates obtained by positioning the high-speed train according to a curve function obtained by fitting point data of the electronic map.

4. The positioning method according to claim 1, wherein the improved differential evolution algorithm is obtained by improving a mutation operation of a differential evolution algorithm; and the mutation operation of the improved differential evolution algorithm is as follows:
arranging individuals in a current generation population in a descending order according to objective function values, and selecting first three individuals as optimal individuals;
randomly selecting three individuals from other individuals in the current generation population except the optimal individuals, and reconstructing a new individual according to the three individuals;
generating an individual in a next generation population according to the new individual and the optimal individuals;
determining whether a number of individuals in the next generation population is equal to a number of individuals in the current generation population:
if yes, completing the mutation operation;
if not, returning to the randomly selecting three individuals from other individuals in the current generation population except the optimal individuals.

5. The positioning method according to claim 4, wherein the reconstructing a new individual according to the three individuals comprises:
randomly selecting one of the three individuals as an original individual;
calculating a first difference between the other two individuals in the three individuals except the original individual, and calculating a product of the first difference and a first variation factor to obtain a first variation;
calculating a sum of the original individual and the first variation, and reconstructing a new individual.

6. The positioning method according to claim 5, wherein the generating an individual in a next generation population according to the new individual and the optimal individuals comprises:
recording the optimal individuals as a first individual, a second individual, and a third individual;
calculating a second difference between the first individual and the original individual, and calculating a product of the second difference and a second variation factor to obtain a second variation;
calculating a third difference between the second individual and the original individual, and calculating a product of the third difference and a third variation factor to obtain a third variation;
calculating a fourth difference between the third individual and the original individual, and calculating a product of the fourth difference and a fourth variation factor to obtain a fourth variation;
calculating a sum of the new individual, the second variation, the third variation, and the fourth variation to obtain an individual in the next generation population.

7. The positioning method according to claim 4, wherein the solving a multi-objective optimization model by using an improved differential evolution algorithm comprises:
randomly generating an initial population according to the second positioning data;
calculating respective objective function values of respective individuals in the initial population, and performing a mutation operation, a crossover operation, and a selection operation on the initial population in sequence according to the objective function values to obtain a new population;
determining whether a maximum iteration number is reached;
if yes, ending the iteration, selecting an individual with a maximum objective function value in the new population as an optimal individual, wherein the optimal individual is the optimal positioning data;
if not, continuing the iteration, deeming the new population as an initial population in a next iteration, and returning to the calculating respective objective function values of respective individuals in the initial population.

8. The positioning method according to claim 7, wherein the randomly generating an initial population according to the second positioning data comprises: generating the initial population by way of adding the second positioning data with random values within an error range.

9. The positioning method according to claim 1, further comprising: after the optimal positioning data of the high-speed train is obtained, performing parameter correction on the BeiDou satellite navigation system and the inertial navigation system according to the optimal positioning data, and performing next positioning using the corrected BeiDou satellite navigation system and the corrected inertial navigation system.

10. A high-precision positioning system for a high-speed train, comprising:
a positioning data acquiring module configured to acquire first positioning data obtained by positioning the high-speed train through a BeiDou satellite navigation system and second positioning data obtained by positioning the high-speed train through an inertial navigation system;
an optimization module configured to solve a multi-objective optimization model with the first positioning data and the second positioning data as inputs thereof, by using an improved differential evolution algorithm, to obtain optimal positioning data of the high-speed train, wherein the multi-objective optimization model comprises an objective function and constraint conditions; the objective function is a function obtained by weighing a positioning error function of the BeiDou satellite navigation system, a distance error function of the inertial navigation system and a direction error function of the inertial navigation system; the constraint conditions comprise a positioning error constraint of the BeiDou satellite navigation system, a distance error constraint and a direction error constraint of the inertial navigation system, and a positioning error constraint of an electronic map.
